(19) United States
(12) Patent Application Publication
(10) Pub. No.: US 2008/0253653 A1
(43) Pub. Date: Oct. 16, 2008

(54) SYSTEMS AND METHODS FOR IMPROVING VISIBILITY OF SCANNED IMAGES

(76) Inventor: Todd Gable, Newark, CA (US)

Correspondence Address: PATRICK W. RASCHE (22697);ARMSTRONG TEASDALE LLP, ONE METROPOLITAN SQUARE, SUITE 2600, ST. LOUIS, MO, 63102-2740, US

(21) Appl. No.: 11/734,515

(22) Filed: Apr. 12, 2007

(51) Int. Cl. G06K 9/34

(52) U.S. Cl. 382/173

(57) ABSTRACT

A method for improving the visibility of a scanned image is provided. The method includes scanning a container to generate the scanned image, where the scanned image includes a container image including at least an object of interest image. The method also includes segmenting the object of interest image from the scanned image and distinguishing the object of interest image from the container image.

### BACKGROUND OF THE INVENTION

This invention relates generally to systems and methods for improving the visibility of scanned images and, more particularly, to systems and methods for identifying a threat substance within three-dimensional scanned image renderings.

Recent events of have instigated an urgency for more effective and stringent screening of airport baggage. The urgency for security expanded from an inspection of carry-on bags for knives and guns to a complete inspection of checked bags for a range of hazards with particular emphasis upon concealed explosives. X-ray imaging is a widespread technology currently employed for screening. However, existing x-ray baggage scanners, including computed tomography (CT) systems designed for detection of explosive and illegal substances, are unable to generate an x-ray image that enables a user to visibly discriminate between harmless materials in certain ranges of density and threat materials, such as, but not limited to, plastic explosives.

### BRIEF DESCRIPTION OF THE INVENTION

In one aspect, a method for improving the visibility of a scanned image is provided. The method includes scanning a container to generate the scanned image, where the scanned image includes a container image including at least an object of interest image. The method also includes segmenting the object of interest image from the scanned image and distinguishing the object of interest image from the container image.

In another aspect, a system for improving the visibility of a scanned image is provided. The system includes a scanner configured to generate the scanned image, where the scanned image includes a container image including at least an object of interest image, and a processor configured to segment an object of interest image from the scanned image and distinguish the object of interest image from the container image.

In yet another aspect, an imaging apparatus for improving the visibility of a scanned image is provided. The imaging apparatus includes a scanning system and a processor configured to generate the scanned image. The scanned image includes a container image including at least an object of interest image. The processor is also configured to segment the object of interest image from the scanned image to distinguish the object of interest image from the container image.

### BRIEF DESCRIPTION OF THE DRAWINGS

FIG. 1 is a simplified block diagram of an exemplary embodiment of a Luggage Inspection Security (LIS) system for improving the visibility of a scanned image;

FIG. 2 is a simplified block diagram of an exemplary Security User Interface (SUI) system shown in FIG. 1;

FIG. 3 is an expanded block diagram of an exemplary embodiment of a server architecture of the SUI system shown in FIG. 2;

FIG. 4 is a perspective view of an exemplary item of luggage;

FIG. 5 is another perspective view of the item of luggage shown in FIG. 4 including an exemplary threat object;

FIG. 6 is a perspective view of the exemplary threat object shown in FIG. 5; and

FIG. 7 is a flowchart of an embodiment of a method for improving a visibility of a scan image.

### DETAILED DESCRIPTION OF THE INVENTION

The methods and systems described herein facilitate quickly and accurately identifying potentially dangerous objects and substances, otherwise known as threat objects, contained in luggage during luggage inspections typically performed at airport inspection workstations. The methods and systems described herein are believed to be applicable to many different businesses for quickly and accurately identifying objects of interest within any type of container. The example embodiment described herein is the transportation security business. Although the transportation security business is the example business described herein, the invention is in no way limited to the transportation security business. For example, the invention may also be used to quickly and accurately inspect freight for potentially dangerous objects and substances, otherwise known as threat objects. It should be appreciated that the term “luggage” as used herein includes any kind of container, such as, but not limited to, suitcases, boxes, trunks, carry-on bags or any kind of baggage.

Exemplary embodiments of systems and processes that facilitate integrated network-based electronic identification of threat objects are described below in detail. The systems and processes facilitate, for example, quickly and accurately identifying threat objects using a Luggage Inspection Security (LIS) system. A technical effect of the systems and processes described herein include at least one of permitting an entity to accurately and quickly identify threat objects contained in luggage. More specifically, in the example embodiment, airport security businesses or other entities engaged in the business of providing luggage inspection services in airports, utilize the methods and systems of the example embodiment to visually distinguish between a luggage background image and a threat object image. Moreover, users of the methods and systems of the example embodiment are able to quickly and accurately identify threat objects contained in luggage by rotating a threat object image.

In the exemplary embodiment, the LIS system is utilized to quickly and accurately identify threat objects contained in luggage. At least some of the parties that may be involved in these systems and processes include airports, system administrators, security personnel and travelers. Airports provide facilities for aircraft, for security personnel conducting manual luggage inspections and for travelers who are passengers on aircraft. System administrator refers to the individuals who maintain the LIS system. Security personnel refers to those individuals who inspect luggage intended for transport on aircraft and accurately identify threat objects contained in luggage.

In the example embodiment, users of the LIS system are able to perform many tasks, such as, but not limited to, quickly and accurately identifying threat objects. In the example embodiment, the LIS system includes a Security User Interface (SUI) system and an Inspection Device (ID) system. The SUI system is electronically coupled to the ID system using a communications link such that they communicate with each other.

In the example embodiment, an item of luggage is processed through an airport inspection workstation area. During processing through the area, an item of luggage is inspected by passing it through the ID system. Because the SUI system communicates with the ID system, the SUI system is able to display threat objects detected in luggage. More particularly, the SUI system is able to detect threat objects and separate them from other objects contained in the luggage. A luggage background image is displayed in a neutral color and a threat object image is displayed in a color associated with a warning. Thus, the luggage background image and the threat object image are distinguishable from each other. By superimposing the threat object image on the luggage background image, security personnel are able to quickly and accurately identify a threat object. For any item of luggage, the LIS system may help a screener review alarm objects and confirm them as harmless or dangerous.

It should be appreciated that although the example discussed above is from the transportation security business, the LIS system may be used in any other business or field of endeavor requiring accurate identification of objects of interest and substances within containers. However, it should be further appreciated that other businesses or organizations may define different criteria for identifying objects of interest and substances tailored to the particular business, and that for each business, object and substance identification criteria may be different.

In one embodiment, a computer program is provided, and the program is embodied on a computer readable medium with a user interface for administration and an interface for standard input and generating reports. In an exemplary embodiment, the system is run on a business-entity intranet. In a further exemplary embodiment, the system is being run in a Windows® NT environment (Windows is a registered trademark of Microsoft Corporation, Redmond, Wash.). The application is flexible and designed to run in various different environments without compromising any major functionality.

The systems and processes are not limited to the specific embodiments described herein. In addition, components of each system and each process can be practiced independently and separately from other components and processes described herein. Each component and process also can be used in combination with other assembly packages and processes.

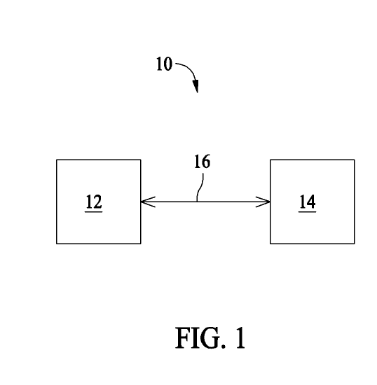

FIG. 1 is a simplified block diagram of an exemplary embodiment of a Luggage Inspection Security (LIS) system 10 for improving the visibility of a scanned image. More specifically, LIS system 10 includes a Security User Interface (SUI) system 12, an Inspection Device (ID) system 14 and a communications link 16. SUI system 12 is described in detail below. It should be understood that ID system 14 includes any known technology that provides high resolution volume images (i.e. three-dimensional images) of luggage contents in an airport environment. For example, ID system 14 may include scanning system technologies, such as, but not limited to, computed tomography scanning systems and magnetic resonance imaging scanning systems. Moreover, ID system 14 includes a movement device or mechanism (not shown) for moving luggage through the scanning system, such as, but not limited to, a conveyor belt. Communications link 16 electronically couples SUI system 12 to ID system 14 such that information may flow through link 16 from ID system 14 to SUI system 12, and vice versa.

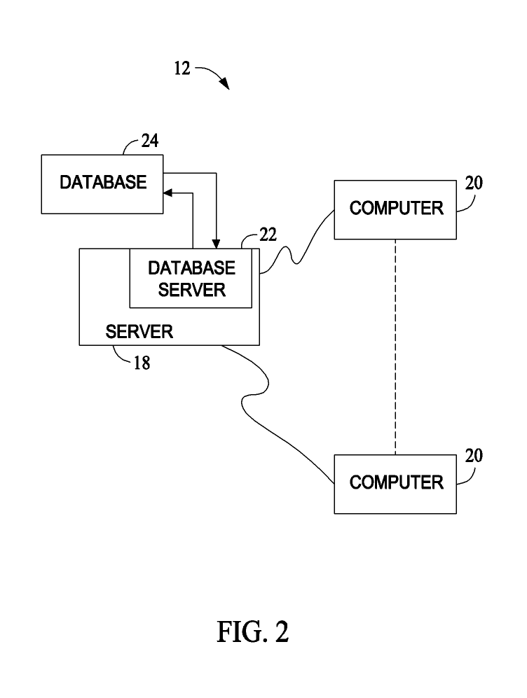

FIG. 2 is a simplified block diagram of an SUI system 12 including a server system 18, and a plurality of client sub-systems, also referred to as client systems 20, connected to server system 18. Computerized modeling and grouping tools, as described below in more detail, are stored in server 18 and can be accessed by a requester at any one of computers 20. A database server 22 is connected to a database 24 containing information on a variety of matters, as described below in greater detail. In one embodiment, centralized database 24 is stored on server system 18 and can be accessed by potential users at one of client systems 20 by logging onto server system 18 through one of client systems 20. In an alternative embodiment, database 24 is stored remotely from server system 18 and may be non-centralized.

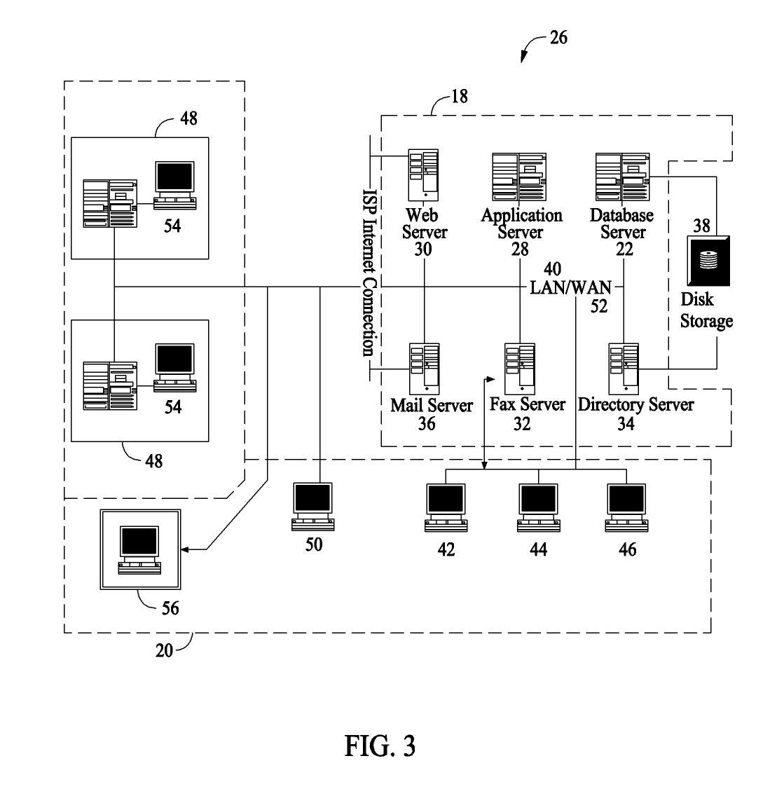

FIG. 3 is an expanded block diagram of an exemplary embodiment of a server architecture of SUI system 26. Components in SUI system 26, identical to components of system 12 (shown in FIG. 1), are identified in FIG. 2 using the same reference numerals as used in FIG. 1. SUI system 26 includes server system 18 and client systems 20. Server system 18 further includes database server 22, an application server 28, a web server 30, a fax server 32, a directory server 34, and a mail server 36. Disk storage unit 38 is coupled to database server 22 and directory server 34. Servers 22, 28, 30, 32, 34, and 36 are coupled in a local area network (LAN) 40. In addition, a system administrator's workstation 42, a user workstation 44, and a supervisor's workstation 46 are coupled to LAN 40.

Each workstation, 42, 44, and 46 is a personal computer. Although the functions performed at the workstations typically are illustrated as being performed at respective workstations 42, 44, and 46, such functions can be performed at one of many personal computers coupled to LAN 40. Workstations 42, 44, and 46 are illustrated as being associated with separate functions only to facilitate an understanding of the different types of functions that can be performed by individuals having access to LAN 40.

Server system 18 is configured to be communicatively coupled to various individuals, including employees 48 and to third parties, e.g., clients/customers 50, using LAN 40. The communication in the exemplary embodiment is illustrated as being performed using LAN 40, however, any other wide area network (WAN) type communication can be utilized in other embodiments, i.e., the systems and processes are not limited to being practiced using LAN 40. In addition, and rather than LAN 40, wide area network 52 or the internet could be used in place of LAN 40.

In the exemplary embodiment, any authorized individual having a workstation 54 can access SUI system 26. At least one of the client systems includes a manager workstation 56. Workstations 54 and 56 are personal computers configured to communicate with server system 18. Furthermore, fax server 32 communicates with client systems, including a client system 56 using a telephone link. Fax server 32 is configured to communicate with other client systems 42, 44, and 46 as well.

Workstations 42, 44, 46, 54 and 56 include computers that may include a device, such as, but not limited to, a floppy disk drive or CD-ROM drive, for reading data including the methods for improving the visibility of a scanned image from a computer-readable medium, such as a floppy disk, a compact disc-read only memory (CD-ROM), a magneto-optical disk (MOD), or a digital versatile disc (DVD). Moreover, workstations 42, 44, 46, 54 and 56 include display devices, such as, but not limited to, liquid crystal displays (LCD), cathode ray tubes (CRT) and color monitors. Furthermore, workstations 42, 44, 46, 54 and 56 include input devices such as, but not limited to, a mouse (not shown) and a keyboard (not shown).

Application server 28 includes a processor (not shown) and a memory (not shown). It should be understood that, as used herein, the term processor is not limited to just those integrated circuits referred to in the art as a processor, but broadly refers to a computer, a microcontroller, a microcomputer, a programmable logic controller, an application specific integrated circuit, and any other programmable circuit. It should be understood that the processor executes instructions stored in application server 28. The above examples are exemplary only, and are thus not intended to limit in any way the definition and/or meaning of the term “processor”.

The memory (not shown) can be implemented using any appropriate combination of alterable, volatile or non-volatile memory or non-alterable, or fixed, memory. The alterable memory, whether volatile or non-volatile, can be implemented using any one or more of static or dynamic RAM (Random Access Memory), a floppy disk and disk drive, a writeable or re-writeable optical disk and disk drive, a hard drive, flash memory or the like. Similarly, the non-alterable or fixed memory can be implemented using any one or more of ROM (Read-Only Memory), PROM (Programmable Read-Only Memory), EPROM (Erasable Programmable Read-Only Memory), EEPROM (Electrically Erasable Programmable Read-Only Memory), an optical ROM disk, such as a CD-ROM or DVD-ROM disk, and disk drive or the like.

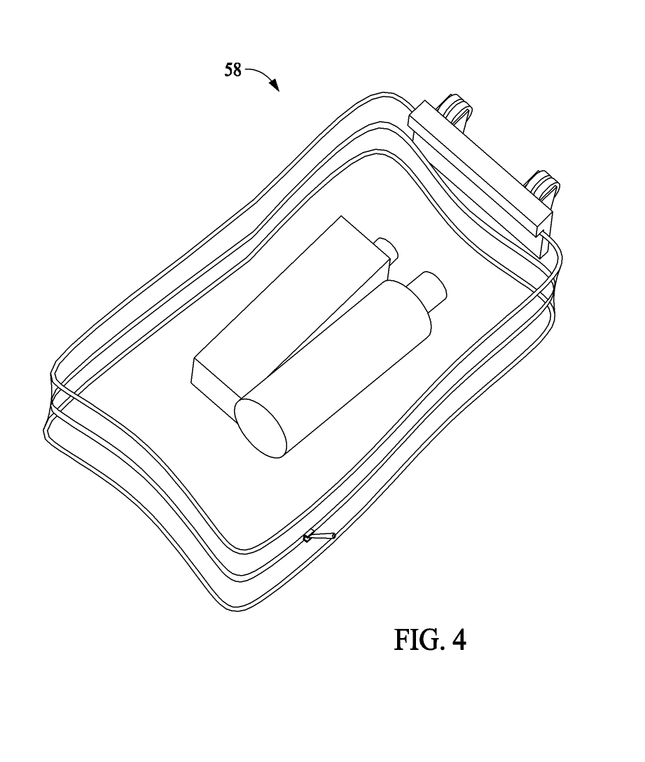

FIG. 4 is a perspective view of an exemplary scanned image 58 of an item of luggage and its contents. The item of luggage may contain any kind of items, such as, but not limited to, shampoo, toothbrush and clothes.

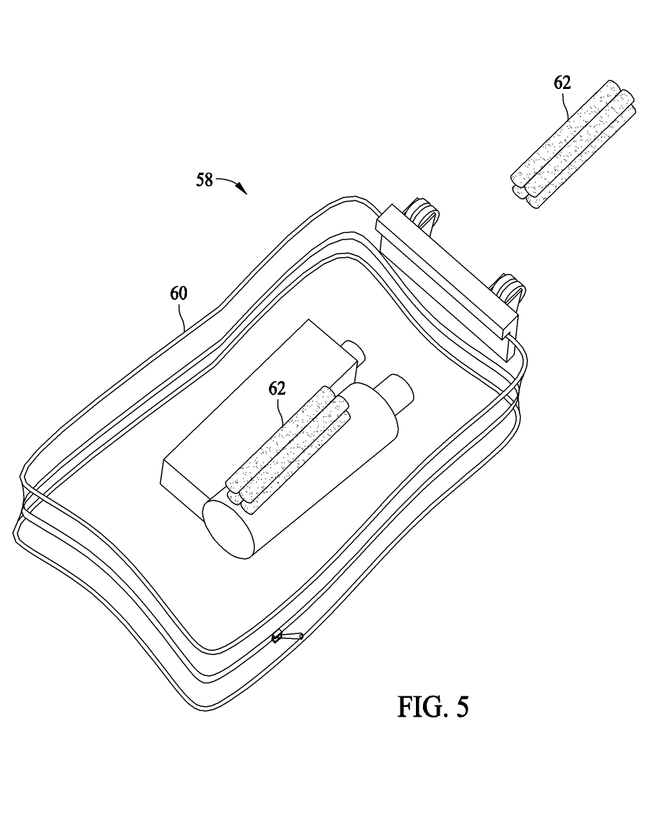

FIG. 5 is another perspective view of image 58 including a threat object. More specifically, image 58 is electronically segmented into a luggage background image 60 and a threat object image 62. It should be understood that luggage background image 60 constitutes image 58, minus threat object image 62, and threat object image 62 constitutes an electronic image of the threat object. Moreover, it should be understood that luggage background image 60 and threat object image 62 are each separate image entities, are stored separately in database 24 and are electronically superimposed on the same three-dimensional coordinate system. Because threat object 62 is stored separately from luggage background image 60, SUI system 26 is able to render background image 60 and threat object image 62 separately or together. It should be appreciated that in the exemplary embodiment, luggage background image 60 and threat object image 62 may be saved in database 24 in files of any applicable files format, such as, but not limited to, vtk files.

In the exemplary embodiment, luggage background image 60 is gray and threat object image 62 is red. It should be appreciated that although the exemplary embodiment is described as displaying luggage background image 60 in gray, in other embodiments, luggage background image 60 may be any neutral color having low opacity and enables LIS system 10 to function as described herein. Moreover, it should be appreciated that although the exemplary embodiment is described as displaying threat object image 62 in red, in other embodiments, threat object image 62 may be any color that is conventionally associated with a warning, has high opacity and enables LIS system 10 to function as described herein.

When rendered together, the item of luggage is displayed similar to original image 58. Because luggage background image 60 and threat object image 62 have different colors, ranges and opacities, the threat objects constituting threat object image 62 are clearly shown in context with, and are distinguishable from, the luggage contents. By displaying threat object image 62 in a high opacity color, versus low opacity for luggage background image 60, the two images are clearly distinguishable on a display screen.

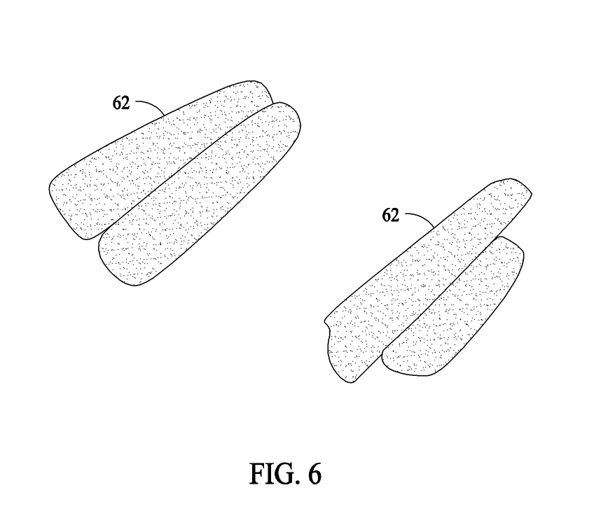

FIG. 6 is a perspective view of threat object image 62. In the exemplary embodiment, while threat object image 62 is rendered separately from luggage background image 60, security personnel analyze and identify the threat object by rotating threat object image 62 to view it from many angles. It should be appreciated that although the exemplary embodiment describes rotating threat object image 62 for detailed analysis and identification, in other embodiments, threat object image 62 may be manipulated in any other fashion, such as, but not limited to, by translation, that enables LIS system 10 to function as described herein.

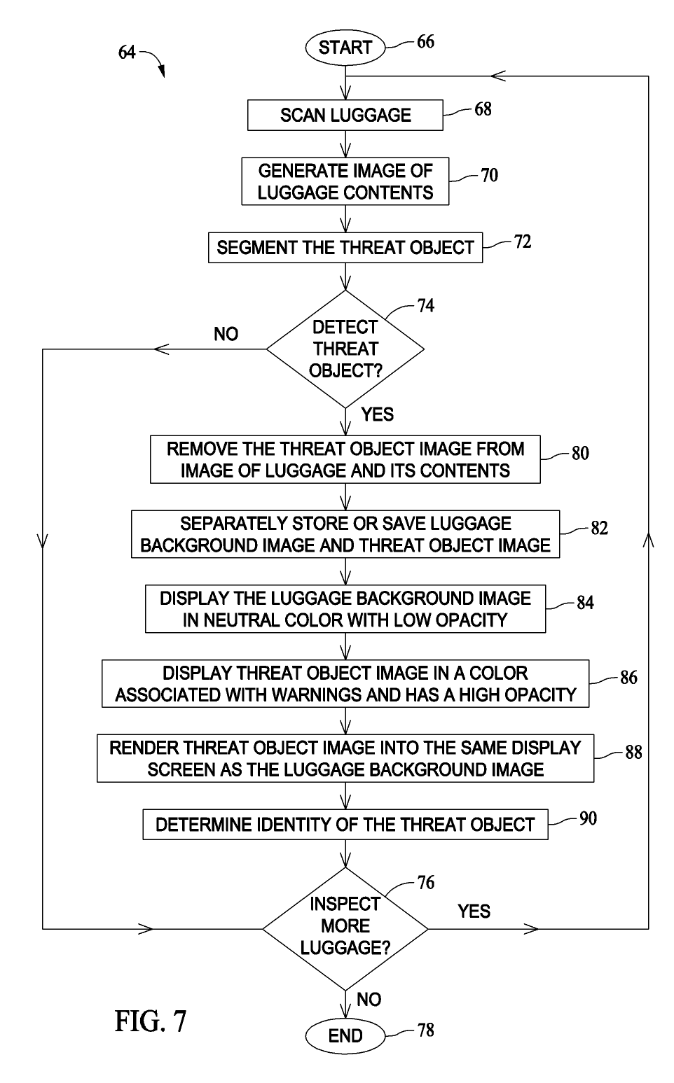

FIG. 7 is a flowchart 64 illustrating exemplary processes used by LIS system 10 (shown in FIG. 1) for quickly and accurately identifying threat objects contained in luggage. For LIS system 10, luggage inspection starts 66 when an item of luggage arrives for inspection and is positioned to pass through ID system 14. IS system 14 scans 68 the luggage and its contents to identify the luggage contents. During the scan, SUI system 26 communicates with ID system 14 such that SUI system 26 generates 70 an electronic three-dimensional image 58 representing the luggage and its contents. SUI system 26 electronically segments 72 the luggage and its contents, including threat objects. If a threat object is not detected 74 during scan 68, another item of luggage may be inspected 76. If no luggage is available for inspection, processing ends 78.

It should be understood that electronically segmenting 72 the threat object involves distinguishing a scanned image of the threat object, i.e., threat object image 62, from a scanned image of the luggage background, i.e., luggage background image 60. More specifically, SUI system 26 electronically segments 72 threat object image 62 based on at least one intensity of threat object image 62 and at least one intensity of luggage background image 60. For example, upon determining by SUI system 26 that a portion of the initial luggage image 58 does not correspond to a luggage background image 60, SUI system 26 determines that the portion is a part of a threat object image 62. As another example, upon determining by SUI system 26 that a portion of the initial luggage image 58 corresponds to a luggage background image 60, SUI system 26 determines that the portion is a part of the luggage background image 60. It should be appreciated that although the exemplary embodiment is descried as electronically segmenting a threat object, in other embodiments, any object within a container may be segmented, thus, enabling LIS system 10 to function as described herein.

After electronically segmenting 72 threat object image 62, SUI system 26 removes 80 threat object image 62 from image 58. Thus, luggage background image 60 comprises luggage image 58 minus threat object 62. Threat object image 62 and luggage background image 60 are separately stored 82 in database 24. After removing threat object image 62, image 58 includes an empty space in the region previously occupied by threat object image 62. Moreover, after removing threat object image 62, regions of non-interest in luggage background image 60, including the empty space, may be rendered transparent or may be rendered with a neutral color. Luggage background image 60 is displayed 84 in a gray color having low opacity 84. Threat object image 62 is rendered in a color conventionally associated with warnings, such as, but not limited to, red, and that has a high opacity 86.

After appropriately coloring luggage background image 60 and threat object image 62, threat object image 62 is rendered 88 into the same display screen with luggage background image 60. By displaying threat object image 62 in a high opacity color, versus low opacity for luggage background image 60, the two images are clearly distinguishable on the same display.

Security personnel analyze and identify 90 the threat object by manipulating a separate rendering of threat object image 62. After analyzing and identifying 90 threat object image 62, if additional items of luggage require inspection 76, the luggage is scanned 68 and processed as described above. Otherwise, processing ends 78.

In the example embodiment, luggage is scanned and potentially dangerous objects and substances, otherwise known as target objects, are detected. More specifically, a method for performing luggage inspections in airports is provided where a user is able to immediately and accurately detect and identify threat objects. A luggage background image is created having a neutral color and a separate target object image is created for a target object. The target object image is colored to contrast with the neutral color of the luggage background image. As a result of creating separate images and coloring them differently, security personnel are able to rotate the target object image to quickly and accurately identify a target object as harmless or dangerous.

While the invention has been described in terms of various specific embodiments, the description of the various embodiments is illustrative only and is not to be construed as limiting the invention. Various other modifications and changes may occur to those skilled in the art without departing from the spirit and scope of the invention.

What is claimed is:

1. A method for improving the visibility of a scanned image comprising:
scanning a container to generate the scanned image, the scanned image comprising a container image including at least an object of interest image;
segmenting the object of interest image from the scanned image; and
distinguishing the object of interest image from the container image.

2. A method in accordance with claim 1 further comprising removing the object of interest image from the scanned image to generate a removed background image including an empty space.

3. A method in accordance with claim 1 further comprising changing a characteristic of the object of interest image to generate a changed object of interest image.

4. A method in accordance with claim 1 further comprising:
removing the object of interest image from the scanned image to generate a removed object of interest image and a removed background image including an empty space;
changing a characteristic of the removed object of interest image to generate a changed object of interest image; and
adding the changed object of interest image to the empty space.

5. A method in accordance with claim 1 further comprising:
removing the object of interest image from the scanned image to generate a removed object of interest image and a removed background image including an empty space;
changing a characteristic of the removed object of interest image to generate a changed object of interest image; and
rotating the changed object of interest image.

6. A method in accordance with claim 1 further comprising:
removing the object of interest image from the scanned image to generate a removed background image including an empty space and a removed object of interest image; and
identifying an object of interest by manipulating the removed object of interest image, wherein manipulating includes at least rotating.

7. A method in accordance with claim 1 further comprising:
removing the object of interest image from the scanned image to generate a removed object of interest image and a removed background image including an empty space;
changing a characteristic of the removed background image to generate a changed background image;
changing a characteristic of the removed object of interest image to generate a changed object of interest image; and
adding the changed object of interest image to the empty space within the changed background image.

8. A method in accordance with claim 1 further comprising:
removing the object of interest image from the scanned image to generate a removed object of interest image and a removed background image including an empty space;
changing a characteristic of the removed background image to generate a changed background image;
changing a characteristic of the removed object of interest image to generate a changed object of interest image; and
rotating the changed object of interest image.

9. A system for improving the visibility of a scanned image, said system comprising:
a scanner configured to generate the scanned image, the scanned image comprising a container image including at least an object of interest image; and
a processor configured to segment an object of interest image from the scanned image and distinguish the object of interest image from the container image.

10. A system in accordance with claim 9 wherein said processor is further configured to:
remove the object of interest image from the scanned image to generate a removed background image including an empty space and a removed object of interest; and
identify an object of interest by manipulating the removed object of interest image.

11. A system in accordance with claim 9 wherein said processor is further configured to change a characteristic of the object of interest image to generate a changed object of interest image.

12. A system in accordance with claim 9 wherein said processor is further configured to:
remove the object of interest image from the scanned image to generate a removed object of interest image and a removed background image including an empty space;
change a characteristic of the removed object of interest image to generate a changed object of interest image; and
add the changed object of interest image to the empty space.

13. A system in accordance with claim 9 wherein said processor is further configured to:
remove the object of interest image from the scanned image to generate a removed object of interest image and a removed background image including an empty space;
change a characteristic of the removed object of interest image to generate a changed object of interest image; and
rotate the changed object of interest image.

14. A system in accordance with claim 9 wherein said processor is further configured to:
remove the object of interest image from the scanned image to generate a removed background image including an empty space; and
change a characteristic of the removed background image to generate a changed background image.

15. A system in accordance with claim 9 wherein said processor is further configured to:
remove the object of interest image from the scanned image to generate a removed object of interest image and a removed background image including an empty space;
change a characteristic of the removed background image to generate a changed background image;
change a characteristic of the removed object of interest image to generate a changed object of interest image; and
add the changed object of interest image to the empty space within the changed background image.

16. A system in accordance with claim 9 wherein said processor is further configured to:
remove the object of interest image from the scanned image to generate a removed object of interest image and a removed background image including an empty space;
change a characteristic of the removed background image to generate a changed background image;
change a characteristic of the removed object of interest image to generate a changed object of interest image; and
rotate the changed object of interest image.

17. An imaging apparatus for improving the visibility of a scanned image, said imaging apparatus comprising:
a scanning system; and
a processor configured to generate the scanned image, the scanned image comprising a container image including at least an object of interest image, and segment the object of interest image from the scanned image to distinguish the object of interest image from the container image.

18. An imaging apparatus in accordance with claim 17, wherein said processor is further configured to:
remove the object of interest image from the scanned image to generate a removed background image including an empty space and a removed object of interest image; and
identify an object of interest by manipulating the removed object of interest image.

19. An imaging apparatus in accordance with claim 17, wherein said processor is further configured to change a characteristic of the object of interest image to generate a changed object of interest image.

20. An imaging apparatus in accordance with claim 17, wherein said processor is further configured to:
remove the object of interest image from the scanned image to generate a removed object of interest image and a removed background image including an empty space;
change a characteristic of the removed object of interest image to generate a changed object of interest image; and
add the changed object of interest image to the empty space.
